(19) United States
(12) Patent Application Publication
(10) Pub. No.: US 2023/0194328 A1
(43) Pub. Date: Jun. 22, 2023

(54) SOLAR ELECTRONIC SCALE

(71) Applicant: Huayun YU, Shenzhen Guangdong (CN)

(72) Inventor: Huayun YU, Shenzhen Guangdong (CN)

(73) Assignees: SHENZHEN UNIQUE SCALES CO., LTD., Shenzhen Guangdong (CN); Reestar International Limited, Kowloon (HK)

(21) Appl. No.: 18/074,471

(22) Filed: Dec. 3, 2022

(30) Foreign Application Priority Data
Dec. 16, 2021 (CN) 202123176371X
Dec. 16, 2021 (CN) 2021231741439
Dec. 16, 2021 (CN) 2021231763758

(51) Int. Cl. G01G 3/06; H02J 7/35; G01G 21/22; G01G 21/28; G01G 19/46

(52) U.S. Cl. CPC G01G 3/06; H02J 7/35; G01G 21/22; G01G 21/283; G01G 19/46

(57) ABSTRACT

The invention discloses a solar electronic scale which comprises a casing without an external interface; a panel is covered with the casing, and together with the casing forms an accommodating cavity; a display assembly is installed in the accommodating cavity, and can display various information to the outside; the sensing component is arranged on the casing and can be in contact with the support platform; wherein the sensing component is used to sense the target weighing object placed on the panel to obtain the target weighing object and transmit the weight information to the display assembly for display; the power supply component includes the battery and the solar charging component, both of which are arranged in the accommodating cavity; the battery is electrically connected to the display assembly, the induction component and the solar charging component, and can balance power consumption for power consumption components in the accommodating cavity through the solar charging assembly. The solar electronic scale can meet the needs of users for weighing anytime and anywhere, and is conducive to ensuring the weighing accuracy of the electronic scale.

### FIELD OF THE INVENTION

The invention relates to the field of electronic scale equipment, in particular to a solar electronic scale.

### BACKGROUND OF THE INVENTION

An electronic scale is a tool for measuring the weight of an object using Hooke's law or the principle of lever balance of force. Taking the weight scale as an example, with the gradual improvement of people's awareness of health management, the electronic weight scale used for weighing has gradually become an important item for every household to ensure the health of family members.

However, the existing electronic scales usually need to replace the battery frequently, or there are electronic scales powered by solar panels, but they still need to be charged externally, which makes it difficult for users to weigh anytime and anywhere. Secondly, because the electronic scale needs to reserve a structure connected to the outside, it is difficult to ensure the stability and reliability of its internal structure, which in turn affects the weighing accuracy of the electronic scale.

### BRIEF SUMMARY OF THE INVENTION

The invention provides a solar-powered electronic scale, which aims to solve the technical problems that the existing solar-powered electronic scale cannot meet the needs of users for weighing anytime and anywhere, and it is difficult to ensure the weighing accuracy of the electronic scale.

The invention provides a solar electronic scale, comprising:

a casing, without external interface;

a panel, which is covered with the casing, and together with the casing, forms a accommodating cavity;

a display assembly, which is installed in the accommodating cavity and can display various information to the outside;

a sensing assembly, which is arranged on the casing and can be in contact with the support platform; wherein, the sensing assembly is used for sensing the target weighing object placed on the panel to obtain the weight of the target weighing object, and transmit the weight information to the display assembly for display;

a power supply assembly, including a battery and a solar charging assembly, the battery and the solar charging assembly are both arranged in the accommodating cavity; the battery is electrically connected to the display assembly, the induction assembly and the solar charging assembly, and can use the solar charging assembly to balance power consumption for the power consumption elements in the accommodating cavity.

In the solar electronic scale of an embodiment of the present invention, the solar charging component includes a solar panel and a power management circuit, and the power management circuit is electrically connected with the solar panel and the battery. After being converted into light energy, the solar panel can charge and store energy and/or perform real-time charging for the battery through the power management circuit.

In the solar electronic scale of an embodiment of the present invention, the display assembly includes a display panel and a control panel. The display panel is mounted on the casing, and the control panel is electrically connected to the sensing assembly, the control panel and the power management circuit and the battery.

In the solar electronic scale of an embodiment of the present invention, the electronic scale further includes an induction switch module, and the induction switch model is arranged in the accommodating cavity and is electrically connected to the control panel and the battery. The induction switch module is used for controlling the opening and closing of the induction assembly through the control panel.

In the solar electronic scale according to an embodiment of the present invention, the sensing switch module includes a capacitive sensing head and a conductive member, and at least one of the capacitive sensing heads is mounted on the casing and is electrically connected to the control panel and the battery. The conductive member is arranged on the side of the panel facing the solar panel, and when the panel is loaded with a target weighing object, the conductive member can be in contact with the capacitive sensing head, so that the capacitance of the capacitive sensing head changes.

In the solar electronic scale of an embodiment of the present invention, the capacitive sensing head is a spring.

In the solar electronic scale according to an embodiment of the present invention, in the accommodating cavity, a boss is arranged on the casing, and the spring is clamped on the boss; when the panel carries a target. When weighing objects, one end of the spring is in contact with the casing, and the other end of the spring is in contact with the conductive member.

In the solar electronic scale according to an embodiment of the present invention, the sensing component includes a support member and a sensor. The support member is installed on the bottom of the casing and is partially exposed at the bottom; the sensor is installed on the support. The sensor is used to sense the weight of the target weighing object when the support element carries the target weighing object placed on the panel.

In the solar electronic scale according to an embodiment of the present invention, the solar electronic scale further includes a light sensing module for obtaining the current light intensity, and the light sensing module is signally connected to the display assembly;

Alternatively, the solar electronic scale further includes a detection module for detecting the current and/or voltage of the solar charging assembly, and the detection module is signally connected to the display assembly.

In the solar electronic scale of an embodiment of the present invention, the solar electronic scale further includes a temperature sensor, and the temperature sensor is signally connected to the display assembly.

Compared with the prior art, the solar electronic scale provided by the embodiment of the present invention at least includes the following beneficial effects:

On one hand, no matter where the solar electronic scale is placed, as long as its solar charging component can receive light, it can convert the received light into light energy, and convert the light energy into electrical energy, so as to provide electrical energy to the battery. The battery balances power consumption for power-consuming components such as display assembly and induction components. There is no need to replace the battery frequently, and there is no need to reserve an external interface on the casing to supplement the power with an external power supply at the charging place, which is obviously beneficial to users anytime, anywhere. Weighing needs to improve user experience.

On the other hand, because the casing does not need to reserve an external interface, it can also reduce the probability of foreign substances entering the accommodating cavity, and considering the problem of stress concentration during the manufacture of the casing, the casing can also be greatly increased. The compressive strength of the solar electronic scale is further favorable to ensure the stability and reliability of the overall structure of the solar electronic scale, especially the internal structure, and ultimately helps to improve the weighing accuracy of the electronic scale.

It is to be understood that the foregoing general description and the following detailed description are exemplary and explanatory only and are not limiting of the invention.

### BRIEF DESCRIPTION OF THE SEVERAL VIEWS OF THE DRAWINGS

The accompanying drawings illustrate one ore more embodiments of the invention and, together with the written description, serve to explain the principles of the invention, and wherein:

FIG. 1 is a schematic structural diagram of a solar electronic scale provided by an embodiment of the present invention;

FIG. 2 is a schematic diagram of the internal structure of the solar electronic scale in FIG. 1;

FIG. 3 is a schematic cross-sectional view of the solar electronic scale in FIG. 1;

FIG. 4 is an exploded schematic diagram of the solar electronic scale in FIG. 1;

FIG. 5 is an exploded schematic view of the power supply assembly in FIG. 4;

FIG. 6 is an exploded schematic view of the display assembly in FIG. 4;

FIG. 7 is a partial enlarged view of part A in FIG. 2; and,

FIG. 8 is an exploded schematic view of the sensing assembly in FIG. 4.

### DETAILED DESCRIPTION OF THE INVENTION

The technical solutions in the embodiments of the present invention will be clearly and completely described below with reference to the accompanying drawings in the embodiments of the present invention. Obviously, the described embodiments are part of the embodiments of the present invention, not all of the embodiments. Based on the embodiments of the present invention, all other embodiments obtained by those of ordinary skill in the art without creative work fall within the protection scope of the present invention.

In the description of the present invention, it should be understood that the term ‘center’, ‘longitudinal’, ‘lateral’, ‘length’, ‘width’, ‘thickness’, ‘upper’, ‘lower’, ‘front’, ‘back’, ‘left’, ‘right’, ‘vertical’, ‘horizontal’, ‘top’, ‘bottom’, ‘inner’, ‘outer’, ‘clockwise’, ‘counterclockwise’ etc. Or the positional relationship is based on the orientation or positional relationship shown in the accompanying drawings, which is only for the convenience of describing the present invention and simplifying the description, rather than indicating or implying that the referred device or element must have a specific orientation, be constructed and operation, so it cannot be construed as a limitation to the present invention. In addition, the term ‘first’ and ‘second’ are only used for descriptive purposes, and should be not construed as indicating or implying relative importance or implying the number of indicated technical features. Thus, features defined as ‘first’, ‘second’ may expressly or implicitly include one or more of said features. In the description of the present invention, ‘plurality’ means two ore more, unless otherwise expressly and specifically defined.

Some embodiments of the present invention will be described in detail below with reference to the accompanying drawings. The embodiments described below and features in the embodiments may be combined with each other without conflict.

A solar electronic scale 10 is provided in the embodiment of the present invention, wherein the solar electronic scale 10 may be a scale for weighing information such as the weight of a human body, and of course, it may also be a scale for weighing other substances such as food, electronic scale with information such as weight. That is, the target weighing object of the solar electronic scale 10 includes people, articles, and the like.

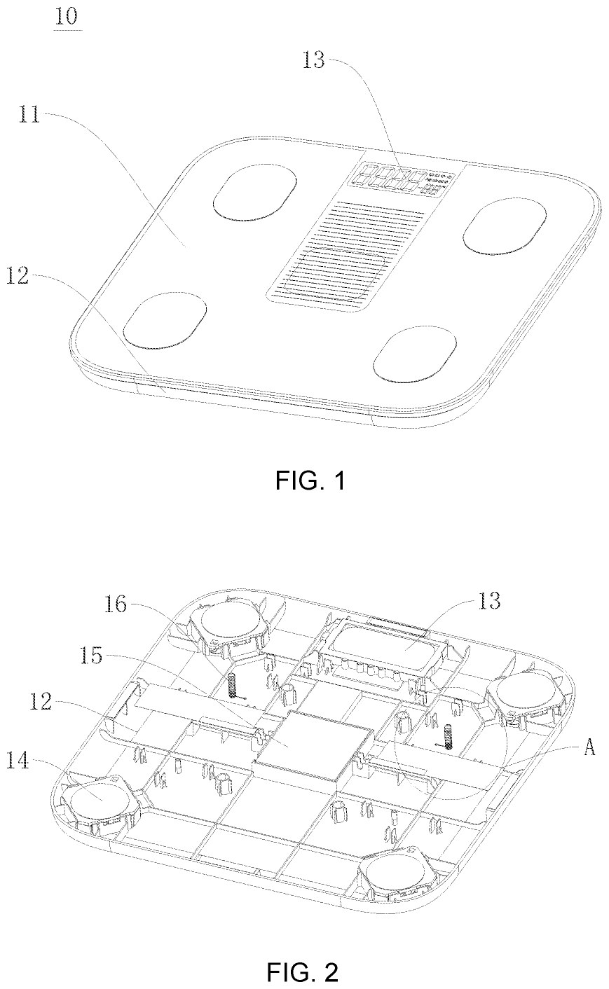

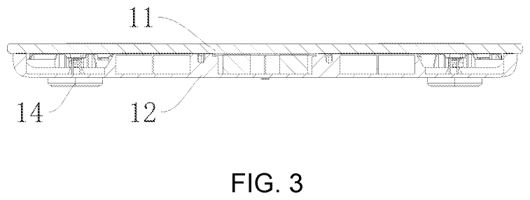

In this embodiment, as shown in FIGS. 1 to 4, the solar electronic scale 10 includes a casing 12, a panel 11, a display assembly 13, a sensing assembly 14 and a power supply assembly 15, wherein the panel 11 is covered with the casing 12, and together with the casing 12, a accommodating cavity (not shown) is formed. Specifically, in the embodiment, the panel 11 is buckled on the casing 12 to cover the casing 12. Of course, in other embodiments, the panel 11 may also be covered on the casing 12 by other suitable methods such as bonding.

In this embodiment, in order to ensure the safe use of the solar electronic scale 10 and improve its service life, the display assembly 13 and the power supply component 15 are both installed in the accommodating cavity (not shown), and the display assembly 13 can display various kind of information. Specifically, in practical applications, people can read various information from the display assembly 13 though the panel 11. It should be noted that the ‘various information’ referred to here includes but is not limited to information such as weight, body mass index (abbreviated as BMI), outdoor temperature, and light intensity.

Among them, in this embodiment, the sensing assembly 14 is disposed on the casing 12 and can be in contact with the support platform. The sensing assembly 14 is used to sense the target weighing object placed on the panel 11 to obtain the weighing target, weight and transmit the weight information to the display assembly 13 for display. It can be understood that when the solar electronic scale 10 is placed on the supporting platform, the end of the sensing assembly 14 is in contact with the supporting platform; in addition, the panel 11 is a bearing panel, and in order to facilitate the exposure of various information displayed by the display assembly 13, the panel 11 may be made of transparent materials such as glass, that is, the panel 11 may be a glass panel.

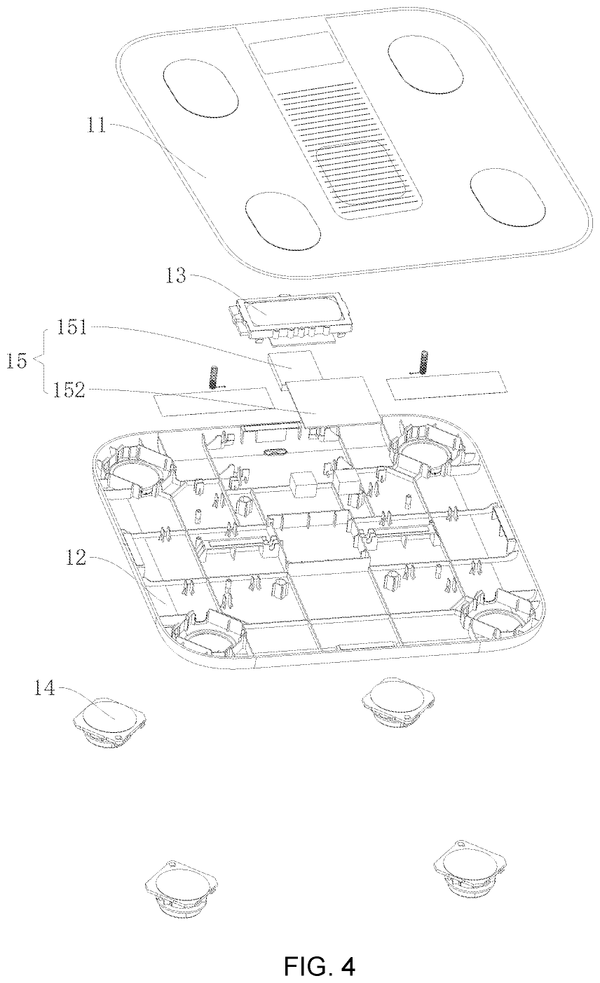

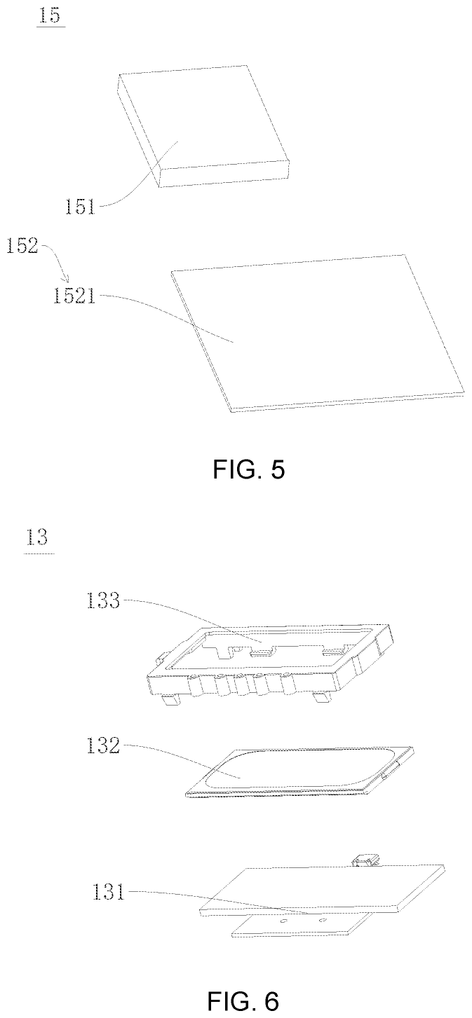

In this embodiment, as shown in FIGS. 4 and 5, the power supply assembly 15 includes a battery 151 and a solar charging assembly 152, wherein the casing 12 does not have an external interface, and both the battery 151 and the solar charging assembly 152 are disposed in the accommodating cavity (not shown); and the battery 151 is electrically connected to the display assembly 13, the sensing assembly 14 and the solar charging component 152, and can perform power for the power-consuming components in the accommodating cavity (not shown) through the solar charging component 152. Consumption balance power supply. Specifically, the power-consuming components such as the display assembly 13 and the sensing assembly 14 are powered by the battery 151, and the battery 151 is charged by the solar charging component 152 to convert the electrical energy from light energy.

It can be understood that, on one hand, no matter where the solar electronic scale 10 is placed, as long as its solar charging assembly 152 can receive light, the received light can be converted into light energy, and the light energy can be converted into electrical energy to supply the battery 151 provides electrical energy for the battery 151 to store backup electrical energy or provide real-time power supply for power-consuming components such as the display assembly 13 and the sensing assembly 14, so as to achieve power consumption balance, which is beneficial to meet the needs of users to weigh anytime and anywhere, and improve the user's convenience. User experience;

On the other hand, because the battery 151 can realize the balanced supply of power and power consumption of the power-consuming components through the solar charging assembly 152, the casing 12 does not need to reserve an external interface for connecting to an external power source for charging, which not only further facilitates the user weighing anytime and anywhere can also reduce the probability of foreign substances entering the accommodating cavity (not shown) and considering the problem of stress concentration during the manufacture of the casing 12, it can also greatly increase the compression resistance of the casing 12. The strength is further beneficial to ensure the overall structure of the solar electronic scale 10, especially the stability and reliability of the internal structure, and ultimately helps to improve the weighing accuracy of the electronic scale.

In an optional embodiment, the solar charging assembly 152 includes a solar panel 1521 and a power management circuit (not shown in the figure), wherein, in order to realize the balanced power supply of the power consumption of the solar electronic scale 10, the power management circuit (not shown in the figure). It is electrically connected to the solar panel 1521 and the battery 151, and after converting the absorbed light into electrical energy, the solar panel 1521 can charge the battery 151 to store energy and/or perform real-time charging through a power management circuit (not shown).

It should be noted that when the solar electronic scale 10 is in a non-working state (specifically, it may refer to a state that is not being weighed) and the battery 151 is not fully charged, the solar panel 1521 can convert the received light into light in time. After the solar energy is finally converted into electrical energy, the electrical energy can be transferred to the battery 151 for storage, so as to ensure that the solar electronic scale 10 remains or tends to be fully charged before the next weighing; In a fully charged state, the battery 151 can also be charged in a timely manner during weighing, thereby ensuring that the power consumption of the power-consuming components is balanced, so that the problem of insufficient power supply and inability to work will not occur.

Specifically, in this embodiment, in order to rationally arrange the components and simplify the overall structure, a power management circuit (not shown in the figure) is provided between the solar panel 1521 and the battery 151.

In an optional embodiment, as shown in FIG. 4 and FIG. 6, the display assembly 13 includes a display panel 132 and a control panel 131, and the display panel 132 is installed in the accommodating cavity. Specifically, in this embodiment, the display assembly 13 further includes a fixing member 133. The fixing member 133 is installed in the accommodating cavity and is connected to the casing 12, and the display panel 132 is installed in the fixing member 133, so as to realize the fixing of the display panel 132 installation and protection. The display panel 132 is close to the panel 11, so that the display assembly 13 can transmit various information to the outside through the display panel 132 for the user to read. Of course, in other embodiments, the display panel 132 may also be installed in the accommodating cavity by other suitable methods such as bonding.

In addition, the control panel 131 is electrically connected to the sensing assembly 14, the power management circuit (not shown) and the battery 151. Specifically, in this embodiment, the control panel 131 is connected to the battery 151, the power management circuit (not shown) and the sensing assembly 14 through wires. It can be understood that when the display assembly 13 is working, the battery 151 is the control panel 131, the display power-consuming components such as the panel 132 provide power, and the control panel 131 can control the opening or closing of the display panel 132, so that the display assembly 13 can display various information to the outside for the user to read. The control panel 131 can also control the power supply balance between the battery 151 and each power consuming element through a power management circuit (not shown).

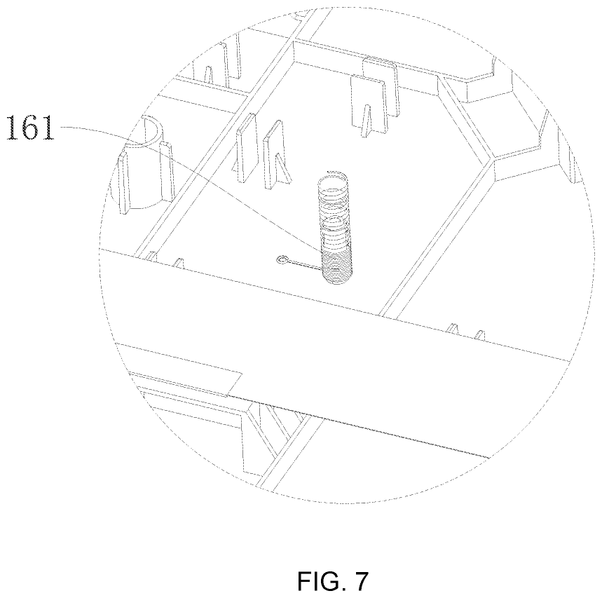

In an optional embodiment, as shown in FIG. 2 and FIG. 7, in order to enable the solar electronic scale 10 to quickly respond to enter the working state, the solar electronic scale 10 further includes an inductive switch module 16, and the inductive switch module 16 is provided with in the accommodating cavity (not shown). Specifically, in this embodiment, the inductive switch module 16 is disposed inside the casing 12. And the inductive switch module 16 is electrically connected to the control panel 131 and the battery 151 for controlling the opening and closing of the sensing assembly 14 through the control panel 131.

It can be understood that the battery 151 provides power for the inductive switch module 16. The inductive switch model 16 can feed back the acquired turn-on signal (turn-off signal) to the control panel 131, so as to control the sensing assembly 14 to turn on (turn off) the inductive weighing function through the control panel 131.

In an optional embodiment, in order to realize the switching function of the inductive switch module 16, the inductive switch module 16 further includes a capacitive sensing head 161 and a conductive member (not shown), and at least one capacitive sensing head 161 is mounted on the casing 12, and is electrically connected to the control panel 131 and the battery 151. Specifically, in this embodiment, the number of capacitive sensing heads 161 is two, and the two capacitive sensing heads 161 are connected in series and are electrically connected to the pins of the control panel 131 and the battery 151.

In addition, a conductive member (not shown) is disposed on the side of the panel 11 facing the solar panel 1521, wherein the conductive member (not shown) can be mounted on the panel 11 by means of bonding or the like. Exemplarily, the conductive member (not shown in the figure) is a thin sheet made of conductive material. Of course, the conductive material such as aluminum and copper can also be a conductive member of other structure or type (not shown in the figure). Specifically, in this embodiment, the conductive member (not shown) is preferably an aluminum film, and the aluminum film is bonded to the panel 11. In other embodiments, the aluminum film can also be other fixed connection methods, which can be selected according to the implementation.

In this embodiment, in order to simplify the overall structure of the solar electronic scale 10, the capacitive sensing head 161 is a spring, including but not limited to a spring, that is, the capacitive sensing head 161 can also be other capacitive sensing elements, which are not added here. Limit.

Specifically, in the accommodating cavity, a boss (not shown in the figure) is provided on the casing 12, and the spring 161 is clamped on the boss (not shown in the figure), when the panel 11 carries the target weighing object, the spring 161. One end of the spring 161 is in contact with the casing 12, and the other end of the spring 161 is in contact with the conductive member (not shown).

It should be noted that when the panel 11 carries the target weighing object, the conductive member (not shown in the figure) can contact the spring 161, and the spring 161 is deformed under pressure, so that the capacitance changes, and the control panel 131 can adjust the capacitance according to the capacitance sensing head. The induction signal of 161 controls the opening of the sensing assembly 14; when the target weighing object on the panel 11 is removed, the conductive member (not shown) does not contact the spring 161, and the spring 161 returns to the initial state, so that the capacitance changes, which is caused by the control panel 131 controls the closing of the sensing assembly 14 according to the sensing signal of the capacitive sensing head 161.

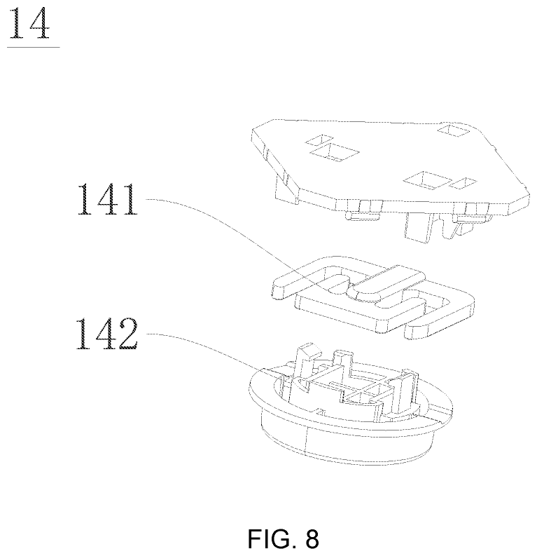

In an optional embodiment, as shown in FIGS. 4 and 8, the sensing assembly 14 includes a support member 142 and a sensor 141, and the support member 142 is mounted on the casing 12. Specifically, in this embodiment, a part of the support member 142 is installed in the accommodating cavity (not shown), and another part of the support member 142 passes through the casing 12 and extends out of the casing 12 to be able to abut against the support plane. In other words, the support member 142 partially exposes the bottom of the casing 12.

In addition, the sensor 141 is installed in the support member 142 and is electrically connected with the battery 151 and the control panel 131 of the display assembly 13. The sensor 141 is used to sense the target weighing object placed on the panel 11 when the support member 142 supports the weight of the target weighing object. Understandably, the battery 151 can supply power to the sensor 141; when the solar electronic scale 10 is placed on the support platform, the end of the support member 142 contacts the support platform, and when the panel 11 carries the target weighing object, the sensor 141. The pressure can be felt to obtain the weight of the target weighing object, and the weight information is directly or indirectly transmitted to the display assembly 13 for display.

In an optional embodiment, the solar electronic scale 10 further includes a light sensing module (not shown in the figure) for obtaining the current light intensity, and the light sensing module (not shown in the figure) is signally connected to the display assembly 13, so that the solar electronic scale 10 can obtain the current light intensity, and display the light intensity level on the display panel 132, so that the user can know the convenient location for charging, so as to meet the charging needs of the scale.

It should be noted that the light intensity is divided into a weak light state, a normal light state, a strong light state and a super strong light state. The low light state is the state of light, the normal light state is the state directly under the light, the strong light state is the state under the sun, the super bright light state is the state of being directly under the sun at noon, for different positions, the solar energy. The charging rates of the electronic scales 10 are different, and the different light intensity levels are displayed on the display panel 132, so that the user can know the location that is convenient for charging, so as to meet the charging requirements of the solar electronic scale 10.

Or, in another optional embodiment, the solar electronic scale 10 further includes a detection module (not shown) for detecting the current and/or voltage of the solar charging assembly 152, the detection module (not shown) and the display assembly 13. The signal connection enables the solar electronic scale 10 to obtain the current light intensity through the detection module (not shown), and displays the light intensity level on the display panel 132, so that the user can know the convenient location for charging, so as to meet the charging needs of the scale.

Exemplarily, a resistor is set on the power management circuit (not shown in the figure), and by obtaining the voltage of the resistor, the magnitude of the current flowing through the resistor can be obtained, and the difference in light intensity can be known according to the magnitude of the current. It is connected with the display assembly 13 by signal, and the light intensity level is displayed through the display assembly 13 for the user's reference.

In an optional embodiment, the solar electronic scale 10 further includes a temperature sensor (not shown), wherein the temperature sensor (not shown) is signally connected to the display assembly 13, and the temperature sensor can acquire the temperature of the surrounding environment. It can be understood that when the solar electronic scale 10 is in a working state, the temperature sensor can also display the sensed external ambient temperature through the display panel 132 of the display assembly 13. Obviously, it is convenient for the user to obtain more information at the same time, which is beneficial to realize the multi-functionalization of the solar electronic scale 10.

In the description of the present invention, it should be noted that, unless otherwise expressly specified and limited, the terms ‘installed’, ‘connected’ and ‘connected’ should be understood in a broad sense, for example, it may be a fixed connection or a connectable connection. Disconnect the connection, or connect it in one piece. It can be a mechanical connection or an electrical connection. It can be directly connected, or indirectly connected through an intermediate medium, and it can be the internal communication between two elements or the interaction relationship between the two elements. For those of ordinary skill in the art, the specific meanings of the above terms in the present invention can be understood according to specific situations.

In the present invention, unless otherwise expressly specified and limited, the first feature cony or ‘under’ the second feature may include the first and second features in direct contact, or may include the first and second features. The features are not in direct contact but though additional features between them. Also, the first feature being ‘above’, ‘over’ and ‘above’ the second feature includes the first feature being directly above and obliquely above the second feature, or simply means that the first feature is level higher than the second feature. The first feature is ‘below’, ‘below’ and ‘below’ the second feature includes the first feature being directly below and diagonally below the second feature, or simply means that the first feature has a lower level than the second feature.

The above disclosure provides many different embodiments or examples for implementing different structures of the present invention. In order to simplify the disclosure of the present invention, the components and arrangements of specific examples are described above. Of course, they are only examples and are not intended to limit the invention. Furthermore, the present disclosure may repeat reference numerals and/or reference letters in various instances for the purpose of simplicity and clarity, and does not in itself indicate the relationship between the various embodiments and/or arrangements discussed. In addition, the present disclosure provides examples of various specific processes and materials, but one of ordinary skill in the art will recognize the application of other processes and/or the use of other materials.

In the description of this specification, reference to the terms ‘one embodiment’, ‘some embodiments’, ‘exemplary embodiment’, ‘example’, ‘specific example’ or ‘some examples’, etc., is meant to incorporate the embodiments. A particular feature, structure, material, or characteristic or exemplified is included in at least on embodiment or example of the present invention. In this specification, schematic representations of the above terms do not necessarily refer to the same embodiment or example. Furthermore, the particular features, structures, materials or characteristic described may be combined in any suitable manner in any one or more embodiments or examples.

Although the embodiments of the present invention have been shown and described, it will be understood by those skilled in the art that various changes, modifications, substitutions and alterations can be made in these embodiments without departing from the principles and spirit of the present invention. Variations, the scope of the present invention is defined by the claims and their equivalents.

What is claimed is:

1. A solar electronic scale comprising:
a casing without external interface;
a panel covering with the casing and forming a accommodating cavity with the casing;
a display assembly installing in the accommodating cavity and displaying various information to the outside;
a sensing assembly arranging on the casing and contacting with the a support platform;
a power supply assembly arranged in the accommodating cavity including a battery and a solar charging assembly;
wherein, the sensing assembly obtains the weight of a target weighing object placed on the panel and transmits the weight information to the display assembly for display, the battery electrically connecting to the display assembly, the sensing assembly and the solar charging assembly uses the solar charging assembly to balance power consumption for the power consumption elements in the accommodating cavity.

2. The solar electronic scale accordingly to claim 1, wherein the solar charging assembly comprises a solar panel and a power management circuit electrically connected to the solar panel and the battery; after absorbing and converting light into light energy, the solar panel charges the battery to store energy and/or perform real-time charging through the power management circuit.

3. The solar electronic scale accordingly to claim 2, wherein the display assembly comprises a display panel mounted on the casing and a control panel electrically connected to the sensing assembly, the power management circuit and the battery.

4. The solar electronic scale according to claim 3, wherein the electronic scale further comprises an inductive switch module disposed in the accommodating cavity and electrically connected to the control panel and the battery; the inductive switch module switches on and off the induction assembly through the control panel.

5. The solar electronic scale according to claim 4, wherein the inductive switch module comprises a number of capacitive sensing heads and a conductive member arranged on the side of the panel facing the solar panel; at least one of the capacitive sensing heads is mounted on the casing and is electrically connected to the control panel and the battery; when the panel carries a target weighing object, the conductive member contacts the capacitive sensing head and changes the capacitance of the capacitive sensing heads.

6. The solar electronic scale according to claim 5, wherein the capacitive sensing head is a spring.

7. The solar electronic scale according to claim 6, wherein the casing comprises a boss; one of the springs is in abutment with the boss of the casing and the other end of the spring is in abutment with the conductive member when a target weighing object is placed on the panel.

8. The solar electronic scale according to claim 3, wherein the sensing assembly comprises a support member mounted on and partially exposed at the bottom of the casing; the sensing assembly comprises a sensor installed in the support member and electrically connected with the battery and the control panel; the sensor senses the weight of a target weighing object when the support member carries a target weighing object placed on the panel.

9. The solar electronic scale according to claim 1, wherein the solar electronic scale further comprises a light sensing module signally connected to the display assembly for obtaining the light intensity; the solar electronic scale further comprises a detection module signally connected to the display assembly for detecting the current and/or voltage of the solar charging assembly.

10. The solar electronic scale according to claim 1 wherein the solar electronic scale further comprises a temperature sensor signally connected to the display assembly.
